(19) United States
(12) Patent Application Publication
(10) Pub. No.: US 2004/0086373 A1
(43) Pub. Date: May 6, 2004

(54) Leveredged wind turbine w/ multiple generators

(76) Inventor: John S. Page JR., Lake Forest, CA (US)

Correspondence Address: JOHN SPLAWN PAGE JR., 25092 FOREST HILL, LAKE FOREST, CA, 92630, US

(21) Appl. No.: 10/288,848

(22) Filed: Nov. 6, 2002

(51) Int. Cl. F03B 15/06

(52) U.S. Cl. 415/4.2

(57) ABSTRACT

The invention is a vertical axis wind turbine that utilizes leverage to compound the force from the wind, thereby creating exstordinary power, enough to turn a plurality of generators, thereby reducing the cost per kilowatt of electricity. It has wind blocking means that when struck by the wind from behind they shift to a position to block the wind to absorb energy from the wind thereby causing the turbine to revolve. At the same time, the wind blocking means on the opposite side of the turbine are being struck by the wind on their front leading edge causing them to rotate up to a position where they do not block wind.

The result is that one half of the turbine is always being driven by the wind to cause rotation while the opposite side of the turbine is always allowing wind to pass through it. It doesn't matter which direction the wind is coming from.

### CROSS REFERENCES TO RELATED APPLICATIONS

### PATENTS WITH VERTICAL DRIVE OR WHEEL TYPE MACHINES

The early examples of vertical drive wheel type wind machines are as listed. U.S. Pat No. 250,806 in 1881 to Hamel; U.S. Pat. No. 5,88,572 in 1897 to Hardaway; U.S. Pat. No. 863,715 in 1907 to Higby; U.S. Pat. No. 864,789 in 1907 to Kickbush; U.S. Pat. No. 1,234,405 in 1917 to Solomon and U.S. Pat. No. 1,382,591 in 1921 to Akermann.

### PATENTS WITH WALLS DEFLETORS OR SHIELDS

The patents that applicant references that had walls, deflectors or shields to block the wind from striking on one half of the wheel are.

U.S. Pat. No. 1,523,295 by Ryan in 1925 and U.S. Pat. No. 1,615,675 by Bender in 1927 and U.S. Pat. No. 1,935,097 by Nelson in 1933 and U.S. Pat. No. 3,970,409 by Luchuk in 1976 and U.S. Pat. No. 4,035,658 by Diggs 1977 and U.S. Pat. No. 4,571,152 by Tater in 1986 and U.S. Pat. No. 4,834,610 by Bond III in 1989 and U.S. Pat. No. 4,269,563 and U.S. Pat. No. 5,038,049.

### BACKGROUND OF THE INVENTION

Wind turbines provide an important source of energy that can be converted into electricity and supplied to utility power grids. Conversion of wind energy to electrical energy is accomplished in a wind turbine by driving an electrical generator, commonly an AC induction generator.

PRIOR ART: Centuries ago the Persians made wind wheels with sails on them, which they used, to mill grain. Fan type windmills were used in Europe and America to also pump water very successfully.

Many inventors have tried to make a vertical drive type wind wheel machine that would generate electricity competitively. Some of the early examples of vertical drive (wheel type) wind machines are as listed on page 19. The main problem with the wheel type vertical drive turbine is that the wind strikes both sides of the wheel turbine and the wind blocking panels receives wind forces equally on both sides. Some inventors had machines with shields to block the wind from striking on one half of the wheel. They had to have some means of adjusting those walls to the changes in the wind direction. See page 18 for list of patents.

The wind industry has left behind the vertical wheel type machines in favor of the horizontal drive, propeller type turbines. They now dominate the wind industry around the world.

However there is now great interest in a turbine that will produce electricity in low velocity winds areas and that would be efficient enough to produce it with lower costs per kilowatt than is done with present technology.

The applicant's entry into this field started with this goal in mind and he soon discovered a way to accomplish that by using the old vertical drive type turbine but with a solution to the wind striking both sides of the turbine. Also part of the goal was to find a way to get more power in the machine.

The secret of the power in many mechanical applications is to use leverage to compound the applied force. Incredible forces can be created in wind turbines by designing into them the leverage principle. The horizontal propeller type turbines also do get more leverage by increasing the diameter of the propellers. However, because when they increase the diameter, they only increase the effective wind-collecting surface a few square inches for each foot extended. Their emphasis is mainly on increasing the wind swept area by increasing the diameter of the blades. However the net result in total power output is significantly less than applicant's LEVERAGED TURBINE which can turn multiple generators.

Applicant's design has resulted in a machine so powerful that it can produce 1,586 foot pounds of torque at the hub with only a wind speed of 2 knots.

The example below will show that in a 6.5-knot wind speed, 16,755 foot pounds of torque can be generated. Another example will show a 20 knots wind speed 158,630 foot pounds of torque can be generated. All of these are with the same size machine. With that incredible power, multiple generators can be driven by one machine.

### BRIEF SUMMERY OF INVENTION

There are many wind devices in the archives of expired patents designed to do work of some kind of work but none that applicant can find that ever disclosed the two unique features of applicant's invention.

The first of the two unique features is a wind turbine that will turn more than one generator.

The drawing in FIG. 2 shows nine generators driven by the one Rotary transmission means on the hub.

Turning multiple generators would not be possible if applicant had not solved the problem of wind striking both sides of a vertical drive turbine and its wind blocking means. Applicant solved this problem with a Wind blocking means that has two unique modes of operation or positions. One is when wind strikes it from behind it rotates down 90 degrees against stops to a wind blocking status, thereby generating thrust to turn the turbine. Then when the turbine revolves around so that the Wind blocking means moves around so that it is traveling side ways through the wind and then straight into the wind, it rotates up 90 degrees to a horizontal position. In that position, it has a low profile so the wind has little to push on to cause drag. It has a unique teeter-totter feature. It is like a teeter-totter that has a long side on one side of the pivot point and a short side on the other side of the pivot point. This makes it unbalanced. However, a counter balance weight is installed on the short side of the unit. This causes it to over power the long side of the unit which causes it to revolve to a horizontal position when the wind flows equally over both the top side and lower side of its surfaces. It operates pneumatically, automatically. The direction that the wind strikes its surfaces determines which position it assumes. There are no gears, pulleys, rods or linkage that mechanically manipulate it, only the counter-balance weight or the wind cause it to revolve around the pivot point one of the two positions.

The result is that one half of the turbine is always being driven by the wind to cause rotation while the opposite side of the turbine is always allowing wind to pass through it. It doesn't matter which direction the wind is coming from.

### BRIEF DESCRIPTION OF DRAWINGS

FIG. 1 is a front ground level view showing schematically the Wind blocking means 2 that are carried by two of the four Frame structures 4 on each side of the Hub 6. There will be at least four Frame structures. Also two of the nine Generators 14 are shown engaging the Rotary transmission means 10 carried by the Hub 6. Also the Brake 16 is shown engaging the Rotary transmission means 10.

FIG. 2 is a plan view looking down on a cross section of the Rotary transmission means 10.

FIG. 3 is side view of the Wind blocking means 2 and how it rotates up 90 degrees to a horizontal position like a wing in the wind and then rotates down to a position to collect the wind like a sail. FIG. 4 is plan view looking down at the Wind blocking means 2. This view only shows the position they would be in during operation. They would not be clustered together as shown. There could be a number of them strung out along the face of the frame structures or there could be just one long Wind blocking means.

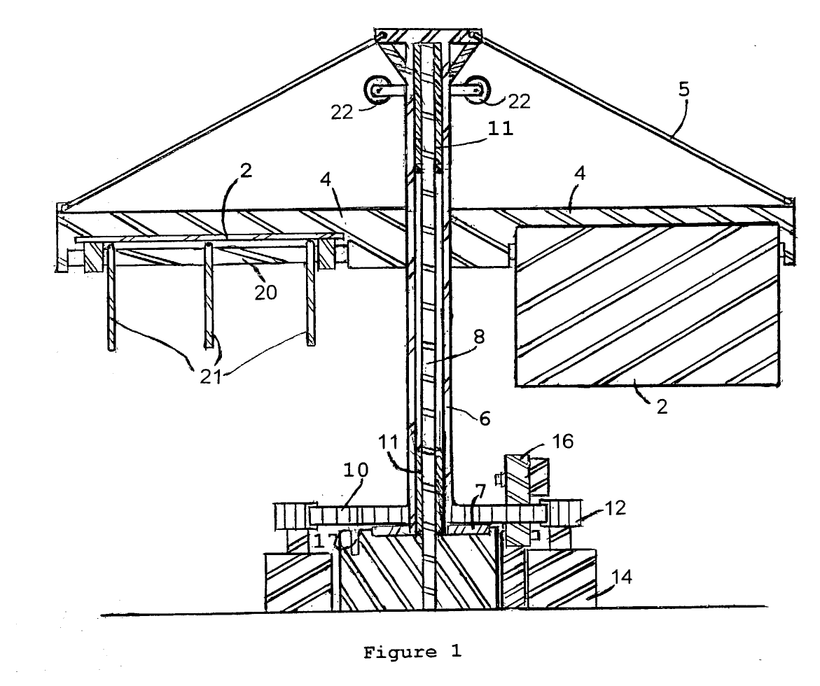

In FIG. 1, the Wind blocking means on the right is in a down position blocking wind and the others are shown in up positions sailing through the wind and not blocking the wind.

### DETAILED DESCRIPTION OF DRAWINGS

FIG. 1 is a front ground level view showing the Wind blocking means 2 that are carried by two of the four Frame structures 4 on each side of the Hub 6. There will be at least four Frame structures 4 extending out from the Hub.

Also two of the multiple Electric Generators 14 are shown as well as the Brake 16. There may be only one Electric Generator or a multiple of Electric Generators depending on how large the frame is and how far out from the Hub 6 the Frame structures 4 extend and how high the Wind blocking means 2 are installed.

FIG. 1 also shows two of four Pulleys 3 to be used with cables and winches to assist in raising the frame structures and for lifting personnel up for maintenance on the turbine.

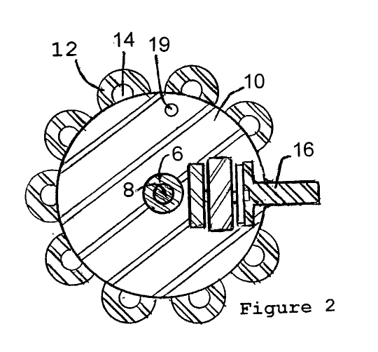

FIG. 2 is plan view looking down on a cross section of the Rotary transmission means 10 and the Generator Gears 12 on the nine Electric Generators 14 engaged with the Rotary transmission means 10. They are shown around the circumference of the Rotary transmission means 10.

The Rotary transmission means 10 also acts as part of the Brake No 16. It has flat surfaces on each side, both top and bottom so that the Brake 16 system have good surfaces to operate on when the brake calipers actuate the Brake. There is a locking means for preventing any rotation of the Hub when any maintenance is required. Having a Hole 17 in the Base 15 and a Hole 19 in the Rotary transmission means 10 does this. A lock pin is inserted through both holes when the holes are in alignment, thereby blocking any rotation.

The Hub 6 is carried by the main Vertical Shaft 8. It revolves around the Vertical Shaft 8 and it turns the Generator Gear 12 on the Electric Generators 14. Roller Bearings 7 are shown between the Rotary transmission means 10 and the Base 15. Column Bearings 11 are shown between the Main Shaft 8 and the Hub 6. Some are near the top and some are at the lower end of them. The Main Shaft 8 and the Hub 6extend high above the Frame structures 4.

Cables 5 are attached to the top of the Hub 6and extend out and down to the Frame structures 4. They support a large part of the load of the Frame structures that are extending far out from the Hub. This too is an important design feature of the invention because it is this support system that makes it practical to have Frame structures extending so far out from the Hub. It is the relative long distance from the Hub that provides the tremendous leverage compounding of torque on the Hub. This FIG. 1 shows only two Wind blocking means 2, one each side, however there can be numerous Wind blocking means 2 on the actual machine. The Wind blocking means 2 on the right side of FIG. 1 is shown in a down position as when the wind has pushed it down against the Stop-weight 21 so that the full thrust of the Wind blocking means 2 pushes on the Frame structure 4 to cause it to revolve. The Wind blocking means 2 can be a panel made of a ridged material or even a sail material stretched over a frame.

On the left side of FIG. 1, the Wind blocking means is shown in its horizontal position as when it comes around to go against the wind. Wind striking it from the front or the side has equal wind force on the top and the bottom of its surfaces, which causes it to seek a horizontal position. Here it is passing through the wind like a wing. The Wind blocking means 2 are carried on a Horizontal Shaft 20 and they swivel and revolve up and down around the Shaft 20. They revolve over a 90-degree range. They are limited to this 90-degree range by two types of stops. One type is the Stop-weight No 21 that limits how far the Wind blocking means 10 can revolve down. The other stop is simply that part of the frame structure that supports the Wind blocking means 10 and prevents it from rotating up too far. FIG. 1 shows the Stop-weight 21 hanging down from the horizontal Shaft 20. These Stop-weights 21 hang and swivel from the Shaft 20 just as the Wind blocking means No 2 do. The purpose of the Stop-weight 21 swinging is that they function not only as stops but because they swing, they allow the Wind blocking means 2 to overpower the Stop-weight when the wind pushes excessively on it and the force is sufficient to start lifting both the Wind blocking means and the Stop-weight 21 up far enough to allow wind to pass under it and out the other side. The Stop-weight 21 has a certain weight that is calculated to yield and be lifted upwardly at a predetermined wind speed. The more it weighs, the more force is required to lift it. Also its length brings the leverage principle into the calculation of the resistance factor. This wind-dumping feature is important so as to limit the speed of rotation of the Rotary transmission means 10 and thereby protect the generators from over speed. No instrumentation is required to monitor the wind speed. The amount of weight that was originally selected for the maximum wind conditions in the particular geographical location that the machine is installed in, is the controlling factor as to when and how much wind is dumped.

The Rotary transmission means and Generators will have a housing to protect them from rain. Proper ventilation for cooling would be incorporated. It is not shown.

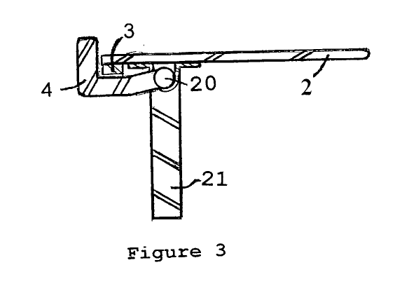

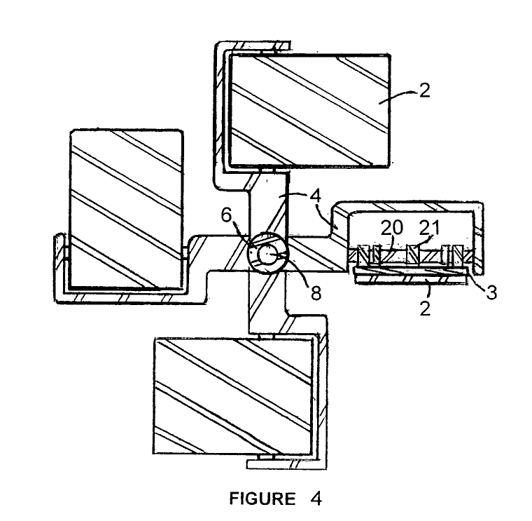

FIG. 3 is side view of the Wind blocking means 2 in an up position and the dotted lines show the 90-degree rotation down to a wind blocking position. Also the weight Stop-weight No 21 is shown hanging from the Shaft 20. The Balance-weight 3 is shown on the left under side of the Wind blocking means.

The Wind blocking means 2 functions like a Teeter-totter. Notice that the pivot-point for the Wind blocking means is the Shaft 20. The Wind blocking means is mounted on the Shaft 20 off set from the center. The distance from the end of the Wind blocking means 2 to the Shaft 20 is quite close while it is a longer distance from the Shaft 20 to the other end of the Wind blocking means. The function of the Balance-weight 3 is to counter balance the imbalance of the Wind blocking means when it is mounted on the Shaft 20. The result is that the Wind blocking means will only respond to the wind for determining its up or down position. It seeks a horizontal position when the wind strikes it from the front, the side or in no wind. This is an important feature of this invention. It is the secret of how the Wind blocking means works so automatically. The long side of the Wind blocking means presents a much larger area for the wind to act on so when the wind strikes-it from that long side [from behind], it overpowers the weight and pushes it down 90 degrees against the Stop-weights. When the Frame structure 4 revolves and brings the Wind blocking means 10 around to face the wind, the Balance weight 3 tries to rotate the Wind blocking means. The wind passing over and under the long part of the Wind blocking means 2 is equal on both the top and bottom sides of the Wind blocking means. This allows the Wind blocking means to seek and maintain a near horizontal position that allows the wind to pass by it freely. They will be stopped in a position to create some lift in order to give some assist in relieving some of the weight of the frame structure because it extends out so far from the hub. This can be done by stopping the upward rotation of the wind blocking means so that they are kept at an angle of attack into the wind that provides some lift. The angle of attack or angle of incidence on an airplane is built into the airplane. It is referred to as: “The angle of incidence at which the wings are attached to the fuselage.” In this wind turbine it is the angle at which the wind blocking means are positioned when they are stopped in the up position.

### EXAMPLE OF LEVERAGE

The principle of leverage is exceedingly powerful. Whatever force is exerted on the Wind blocking means is multiplied by the distance in feet to the Hub. The Wind blocking means start at 4 feet from the Hub and extends out to 76 feet from the Hub. It extends vertically 30 feet high. The dimensions of the wind blocking means on this turbine is 76 feet minus the 4 feet which is 72 feet by 30 feet high and this is 2160 total square feet of area.

To calculate the leverage, take the one-foot wide column 30 feet high and you have 30 square feet of area. Then multiply that by the pounds per square foot of force on the Wind blocking means. The following example uses a force of 0.2154 pounds per square foot on the Wind blocking means. This results in 6.462 foot pounds of force on that one-foot by 30-foot column. This 6.462 number is multiplied by the 76 foot distance to the Hub and that results in 491 foot pounds of torque on the Hub.

Here is how the wind force of 0.2154 pounds per square foot is calculated.

Equation for the force of wind at sea level:

At sea level 0.0034=C=V=V=S

C—is a drag coefficient of 1.5

V—is the velocity of wind and it is squared. Example: 6.5 knots wind.

Velocity is 6.5 knots×6.5 knots

S—area of the sail is 1 square foot.

0.0034×1.5×6.5×6.5×1=0.2154 pounds per square foot.

Therefore, 0.2154 pounds per square foot times 30 square feet equals 6.462 times 76 feet (the distance to the Hub) and it results in 491 foot pounds of torque at the Hub. Then at 75 feet the result is 484 foot pounds of torque at the hub. Notice that for each foot less distance from the Hub, there is 6.462 pounds less torque at the Hub. This is the long way to calculate the torque on the hub but it helps a person envision how the forces are compounded.

Here is how the numbers add up to an amazing total torque at the Hub. These numbers have been rounded down to not include the fractions to the right of the decimal.

| DISTANCE = FORCE | DISTANCE = FORCE | DISTANCE = FORCE |
|---|---|---|
| 76 feet is 491, | 75 feet is 484, | 74 feet is 478, |
| 73 feet is 471, | 72 feet is 465, | 71 feet is 458, |
| 70 feet is 452, | 69 feet is 446, | 68 feet is 439, |
| 67 feet is 413, | 66 feet is 407, | 65 feet is 400, |
| 64 feet is 394, | 63 feet is 387, | 62 feet is 381, |
| 61 feet is 374, | 60 feet is 368, | 59 feet is 361, |
| 58 feet is 355, | 57 feet is 349, | 56 feet is 342, |
| 55 feet is 336, | 54 feet is 329, | 53 feet is 323, |
| 52 feet is 316, | 51 feet is 310, | 50 feet is 303, |
| 49 feet is 290, | 48 feet is 284, | 47 feet is 277, |
| 46 feet is 271, | 45 feet is 271, | 44 feet is 265, |
| 43 feet is 258, | 42 feet is 252, | 41 feet is 245, |
| 40 feet is 232, | 39 feet is 226, | 38 feet is 226, |
| 37 feet is 219, | 36 feet is 213, | 35 feet is 206, |
| 34 feet is 200, | 33 feet is 200, | 32 feet is 193, |
| 31 feet is 187, | 31 feet is 180, | 30 feet is 187, |
| 29 feet is 174, | 28 feet is 168, | 27 feet is 161, |
| 26 feet 155, | 25 feet is 148, | 24 feet is 142, |
| 23 feet is 135, | 22 feet is 116, | 21 feet is 109, |
| 20 feet is 103, | 19 feet is 96, | 18 feet is 90, |
| 17 feet is 84, | 16 feet is 77, | 15 feet is 71, |
| 14 feet is 64, | 13 feet is 58, | 12 feet is 51, |
| 11 feet is 45, | 10 feet is 38, | 9 feet is 32, |
| 8 feet is 26, | 7 feet is 20, | 6 feet is 13, |
| 5 feet is 7. | | |

This example does not have any Wind blocking means closer than 4 feet from the Hub.

In this example with a wind speed of 6.5 knots a total of 18,902 footpounds of torque is applied at the Hub by leverage. There are other factors that effect net torque at the Hub such as the efficiency of the machine etc.

The horizontal wind turbines that now dominate the wind power field require 2,010 horsepower to turn one generator for 1500 Kilo Watt output.

As can be seen incredible forces can be created when the leverage principle is designed into a wind turbine and it is enough to turn MULTIPLE GENERATORS.

Another example to illustrate how powerful the leverage principle is, is a unit that is the same size as the one described above but the calculations for the torque are based on a wind speed 13 knots which is double the wind speed. When wind speed is doubled the force is quadrupled.

Equation for the force of wind at sea level:

At sea level 0.0034=C=V=V=S

C—is a drag coefficient of 1.5

V—is the velocity of wind and it is squared. Example 13 knots.

Velocity is 13 knots×13 knots

S—area of the sail is 1 square foot.

0.0034×1.5×13×13×1=0.8619 pounds per square foot.

Therefore, wind is 0.8619 pounds per square foot times the 30 foot high Wind blocking means which equals 25.857 total pounds of force applied on that one foot by 30 foot column. Then multiply that 25.857 pounds by 76 feet of distance to the Hub and a total force of 1965 foot pounds of torque is applied at the hub. That is just for one 12-inch wide column of Wind blocking means 30 feet high. Then there is a one-foot wide column 30 feet high next to the 76-foot column, which is 75 feet. Therefore, take the 25.857 pounds and multiply it by 75 feet and the result is 1939 foot pounds of torque at the hub. Then proceed to do the same calculation for each foot of distance. Notice that for each foot less distance to the Hub, there is 25.857 pounds less torque at the Hub. Here is how the numbers stack up if you do it foot by foot.

Torque on the Hub at:

| DISTANCE = FORCE | DISTANCE = FORCE | DISTANCE = FORCE |
|---|---|---|
| 76 feet is 1965, | 75 feet is 1939, | 74 feet is 1913, |
| 73 feet is 1887, | 72 feet is 1861, | 71 feet is 1835, |

If you continue adding up the force on each one foot by 30 foot high column of Wind blocking means you have a total of 70,744 foot pounds of torque on the Hub.

Another way to calculate the total force is as follows.

Instead of calculating foot by foot, we take the total square feet area of the Wind blocking means of 2160 and multiply it by the 0.8619 which is what the formula gave as the pounds per square foot in a 13-knot wind and the result is 1861 pounds. Then multiply 1861 pounds times half the distance of 76 foot to the Hub which is 38 feet and the result is: 38×1861=70,744 foot pounds of torque on the Hub. The result is the same either way it is calculated.

To further illustrate the power of the leverage principle consider the following examples compared. If the Wind blocking means measure 30 feet by 72 feet, there is a total square foot area of 2160. If that 2160 feet of wind blocking means is installed with the 76 feet running horizontally so the farthest point from the hub is 76 feet and the 30 feet is installed vertically, then the force on the hub is calculated thus: 2160 square feet of wind blocking means times the force of 0.8619 is 1861 pounds and that is then multiplied 1861 by one half the distance to the hub which is 38 feet resulting in total torque on the hub of 70,744.

Compare that to the same amount of area on the wind blocking means of 2160 and the same total force of 1861 pounds and install it with the 76 feet extending vertically and the 30 feet horizontally, then the same 1861 pounds of force is again multiplied by one half the distance to the hub which is only 15 feet instead of 38 feet and the result is 29,475 total torque on the hub. That is 45,200 pounds less torque on the hub than the first example.

Clearly, by designing into a wind turbine the leverage principle, incredible forces are created. Only the applicant has recognized this principle and harnessed it into a wind turbine.

The example described has frame structures that extend out approximately 23 meters or 76 feet from the Hub. This would be 46 meters or 152 feet in total diameter as compared to the large horizontal propeller type turbines that are 100 meters in diameter and only generate 1500 kilowatts. That makes applicant's turbine only 46 percent as large in diameter as the 1500-kilowatt propeller type turbines and applicant's turbine will produce far more electricity. Also, it requires less land area, which can be a significant consideration.

The following is a list of foot pounds of torque that can be generated with different wind speeds. These amounts were arrived at using the wind speed formula explained above.

| WIND SPEED | |
|---|---|
| IN KNOTS | FOOT POUNDS OF TORQUE PRODUCED |
| 2 | 1586 |
| 3 | 3569 |
| 4 | 6345 |
| 5 | 9914 |
| 6 | 14,276 |
| 7 | 19,432 |
| 8 | 27,713 |
| 9 | 32,122 |
| 10 | 39,657 |
| 11 | 47,985 |
| 12 | 57,107 |
| 13 | 67,021 |
| 14 | 77,728 |
| 15 | 89228 |
| 16 | 101,523 |
| 17 | 114610 |
| 18 | 128,490 |
| 19 | 143,163 |
| 20 | 158,630 |
| 25 | 261,630 |

1. A single wind turbine with means of conveying rotational energy to operate a plurality of generators to produce electricity,

2. A wind turbine comprising:
a) a foundation-base supporting a shaft,
b) a hub carried by said shaft,
c) rotary transmission means carried on said hub,
d) frame structure carried by said hub,
e) wind blocking means, carried on said frame structure extending radially from said hub to a length distance dimension from the hub that is at least 50% greater than the width dimension of the wind blocking means which is at right angles to the length dimension, thereby making more square feet of the area of the wind blocking means in use at a greater distance to the hub to achieve the mechanical leverage and increase the torque at the hub to cause the rotary transmission means to transfer work energy forces to some other mechanism to do work,

3. The claim of claim 2 whereby, the wind blocking means on the frame structure are installed so that more than one half of the total square foot area of the wind blocking means is installed at distances greater than 20 feet from the hub,

4. A vertical axis wind turbine comprising:
a) a foundation-base supporting a vertical shaft,
b) a hub carried by said shaft,
c) rotary transmission means carried on said hub,
d) frame structure carried by said hub and extending radially from said hub,
e) wind,blocking means carried on said frame structure,
whereby, when the wind blows on the wind blocking means, they respond and operate between two different positions, whereas if they are on one side of the hub they shift to a position to allow oncoming wind to pass by them and then when the hub and frame structure rotate and carry them around toward the opposite side of the hub, they shift to a position to block and accept the thrust from the wind to cause the hub to rotate the rotary transmission means and produce work energy forces,

4. The claim of claim 3 whereby said wind blocking means is carried on shafts, said shafts are carried on said frame structures and wind blocking means are attached onto the shafts by a means that allows them to swivel and rotate on the shafts between a position that allows wind to pass by them and then shift to a different position to block the wind and accept the thrust from the wind thereby causing the frame structure and the hub to rotate the Rotary transmission means to produce work energy forces.

5. The claim of claim 4 whereby said wind blocking means are mounted on said shaft so that the distance from one end of said wind blocking means to the horizontal shaft that it is mounted on is quite close while it is a longer distance from the shaft to the other end of the wind blocking means and a balance-weight is attached onto the short side of the wind blocking means to counter balance the longer heavier side of the wind blocking means thereby causing the wind blocking means to rotate to a position of not blocking the wind when the wind does not strike it from behind,

6. The claim of claim 3 that includes a counter balance weight that is installed on the short side of the wind blocking means that causes it to over power the long side of the wind blocking means and revolve to a horizontal position when the wind flows equally over both the top side and lower side of its surfaces creating a neutral position for the wind blocking means so that it is only the wind striking it from behind, its side or front leading edge surfaces that determines which position it assumes whether to block the wind or to not block the wind.

7. The claim of claim 4 whereby said frame structure stops said wind blocking means in a position that provides an angle of attack into the wind that provides some lift to the frame structure,

8. The claim of claim 3 whereby said hub extends up higher than the height of said frame structures and support cables or shafts attached to the high part of said hub extend down to the frame structures where they are attached, thereby supporting much of the weight of the frame structures.

9. The claim of claim 3 whereby said Rotary transmission means carried by said hub is a part of a disk brake system.

10. The claim of claim 3 that includes heisting means carried by said hub for raising and lowering material or personnel up and down the hub.
